(19) United States
(12) Patent Application Publication
(10) Pub. No.: US 2024/0249123 A1
(43) Pub. Date: Jul. 25, 2024

(54) System and Method for Low-Rank Tensor Decomposition with Neural Network Priors

(71) Applicant: William Marsh Rice University, Houston, TX (US)

(72) Inventors: Vishwanath Raja Venkata SARAGADAM, Houston, TX (US); Randall BALESTRIERO, Houston, TX (US); Ashok VEERARAGHAVAN, Houston, TX (US); Richard BARANIUK, Houston, TX (US)

(73) Assignee: William Marsh Rice University, Houston, TX (US)

(21) Appl. No.: 18/182,924

(22) Filed: Mar. 13, 2023

Related U.S. Application Data
(60) Provisional application No. 63/319,041, filed on Mar. 11, 2022.

(51) Int. Cl. G06N 3/0475

(52) U.S. Cl. CPC G06N 3/0475

(57) ABSTRACT

A method and a system for a computationally efficient framework for low-rank decomposition of matrices and tensors using neural generative networks is disclosed. The method includes decomposing a tensor into a plurality of low-rank tensor factors and generating each low-rank tensor factor by a corresponding neural network. Further, the method includes feeding each neural network with a corresponding plurality of input tensors.

### CROSS-REFERENCE TO RELATED APPLICATIONS

This application claims priority to U.S. Provisional Application Ser. No. 64/319,041, filed Mar. 11, 2022, hereby incorporated herein by reference.

### STATEMENT REGARDING FEDERALLY SPONSORED RESEARCH

This invention was made with government support under Grant No. FA9550-18-1-0478 awarded by the Air Force Office of Scientific Research, Grant No. CCF-1730574 awarded by the National Science Foundation, Grant No. CCF-1911094 awarded by the National Science Foundation, Grant No. U.S. Pat. No. 1,652,633 awarded by the National Science Foundation, Grant No. U.S. Pat. No. 1,838,177 awarded by the National Science Foundation, Grant No. N00014-18-1-2047 awarded by the Office of Naval Research, Grant No. N00014-18-1-2571 awarded by the Office of Naval Research, Grant No. N00014-20-1-2534 awarded by the Office of Naval Research, and Grant No. N00014-20-1-2787 awarded by the Office of Naval Research. The government has certain rights in the invention.

### BACKGROUND

Low-rank representations of tensors, e,g, matrices, are truly ubiquitous and applied across all fields of science and engineering, from statistics to control systems to computer vision, and beyond. Low-rank representations seek to represent a large tensor as a product of smaller (and hence lower rank) matrices or fibers. For instance, the classical approach to representing matrices in a low-rank manner is via the singular value decomposition (SVD), which expresses a matrix as a product of two smaller orthonormal matrices (containing the singular vectors) and a diagonal matrix (containing the singular values). Thresholding the singular values creates a matrix that inhabits a lower dimensional subspace. The SVD is a pervasive technique for data preprocessing and dimensionality reduction across a wide entire range of machine learning (ML) applications, including principal component analysis (PCA) and data whitening.

No matter how powerful or pervasive, however, the SVD and PCA are not without their shortcomings. SVD or PCA is an optimal low-rank decomposition technique only under a narrow set of assumptions on the statistics of the signal and noise in the task at hand. When the signal or noise is non-Gaussian, the resulting decomposition is not optimal and results in a subspace that differs from the true low-rank approximation of the underlying matrix. These issues have been addressed somewhat successfully in the past with several signal- and application-specific regularizers that include sparsity on error, total variation penalty, and data-driven approaches. The key observation is that a good signal model can act as a strong regularizer for estimating the low-rank factors. Unfortunately, finding a useful signal model or regularizer for a new application can be a daunting task.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method for low-rank decomposition of a tensor. The method includes decomposing a tensor into a plurality of low-rank tensor factors and generating each low-rank tensor factor by a corresponding neural network. Further, the method includes feeding each neural network with a corresponding plurality of input tensors.

In general, in one aspect, embodiments disclosed herein relate to a system for low-rank decomposition of a tensor including a database computer processor, wherein the computer processor comprises functionality for decomposing a tensor into a plurality of low-rank tensor factors and generating each low-rank tensor factor by a corresponding neural network. Further, the computer processor comprises functionality for feeding each neural network with a corresponding plurality of input tensors.

In general, in one aspect, embodiments disclosed herein relate to a non-transitory computer readable medium storing a set of instructions executable by a computer processor, the set of instructions including the functionality decomposing a tensor into a plurality of low-rank tensor factors and generating each low-rank tensor factor by a corresponding neural network. Further, each neural network is fed with a corresponding plurality of input tensors.

Other aspects and advantages of the claimed subject matter will be apparent from the following description and the appended claims.

### BRIEF DESCRIPTION OF DRAWINGS

Specific embodiments disclosed herein will now be described in detail with reference to the accompanying figures. Like elements in the various figures are denoted by like reference numerals for consistency. Like elements may not be labeled in all figures for the sake of simplicity.

FIG. 1A shows a low-rank tensor decomposition system in accordance with one or more embodiments.

FIG. 1B shows a comparative system in accordance with one or more embodiments.

FIG. 2 shows a flowchart for low-rank tensor decomposition in accordance with one or more embodiments.

FIG. 3A shows an architecture of a 1D network in Deep Image Prior in accordance with one or more embodiments.

FIG. 3B shows an architecture of a 2D network in Deep Image Prior in accordance with one or more embodiments.

FIG. 4 shows a computer system in accordance with one or more embodiments.

FIG. 5 shows a graph of mean squared error as a function of epoch in accordance with one or more embodiments.

FIG. 6 shows a graph of mean squared error as a function of time in accordance with one or more embodiments.

FIG. 7A shows a graph of peak signal-to-noise ratio as a function of rank, under Gaussian noise settings, in accordance with one or more embodiments.

FIG. 7B shows a graph of peak signal-to-noise ratio as a function of rank, under Poisson noise settings, in accordance with one or more embodiments.

FIG. 7C shows a graph of peak signal-to-noise ratio as a function of rank, under Rician noise settings, in accordance with one or more embodiments.

FIG. 8A shows a graph of peak signal-to-noise ratio as a function of standard deviation in accordance with one or more embodiments.

FIG. 8B shows another graph of peak signal-to-noise ratio as a function of standard deviation in accordance with one or more embodiments.

FIG. 8C shows a graph of peak signal-to-noise ratio as a function of number of samples in accordance with one or more embodiments.

FIG. 9A show a graph of a stopping epoch as a function of input noise level in accordance with one or more embodiments.

FIG. 9B show a graph of mean squared error as a function of epoch in accordance with one or more embodiments.

FIGS. 10A and 10B show exemplary effects of choice of rank in accordance with one or more embodiments.

FIG. 11 shows an example of for scientific computing in accordance with one or more embodiments.

FIG. 12 shows an example of hyperspectral denoising in accordance with one or more embodiments.

FIG. 13 shows an example tensor testing in accordance with one or more embodiments.

FIG. 14 shows an example video compressive sensing in accordance with one or more embodiments.

FIG. 15 shows an example reconstruction from 3D CT measurements in accordance with one or more embodiments.

FIG. 16A shows example eigenfaces for facial classification in accordance with one or more embodiments.

FIG. 16B the accuracy of eigenface decomposition for the eigenfaces of FIG. 15A in accordance with one or more embodiments.

### DETAILED DESCRIPTION

In the following detailed description of embodiments disclosed herein, numerous specific details are set forth in order to provide a more thorough understanding disclosed herein. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

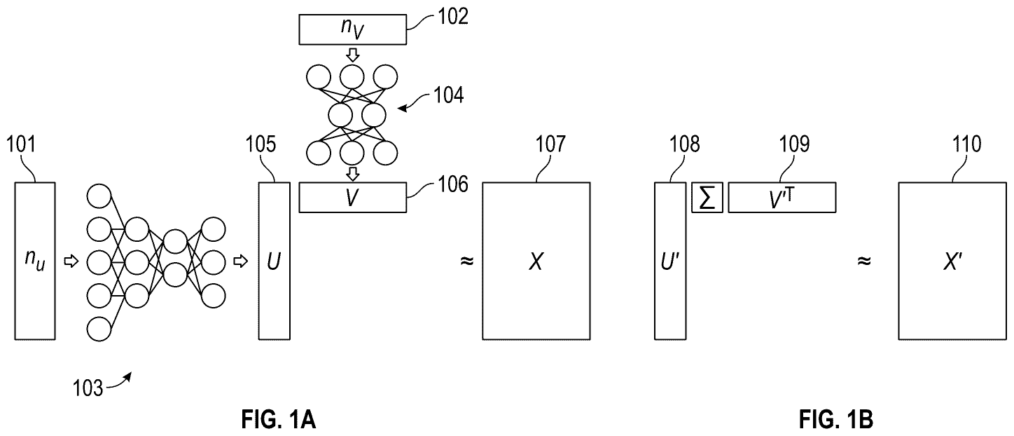

In the following description of FIGS. 1-16, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Embodiments disclosed herein provide a system and method for a computationally efficient framework for low-rank decomposition of matrices and tensors using neural generative networks. While neural networks are illustrated herein with deep networks, it will be understood that the neural networks are not limited to deep networks. As used herein, a deep network is a neural network with more than two layers. The method, DeepTensor, includes decomposing a tensor as the product of low-rank tensor factors (e.g., a matrix as the outer product of two vectors), where each low-rank tensor is generated by a deep network (DN) that is trained in a self-supervised manner to minimize the mean-square approximation error. The observation of this disclosure is that the implicit regularization inherent in DNs enables them to capture nonlinear signal structures (e.g., manifolds) that are out of the reach of classical linear methods like the singular value decomposition (SVD) and principal components analysis (PCA). Furthermore, in contrast to the SVD and PCA, whose performance deteriorates when the tensor's entries deviate from additive white Gaussian noise, we demonstrate that the performance of the disclosure is robust to a wide range of distributions. We validate that the disclosure provides a robust and computationally efficient drop-in replacement for the SVD, PCA, nonnegative matrix factorization (NMF), and similar decompositions by exploring a range of real-world applications, including hyperspectral image denoising, 3D MRI tomography, and image classification. In particular, the disclosure offers a 6 dB signal-to-noise ratio improvement over standard denoising methods for signal corrupted by Poisson noise and learns to decompose 3D tensors 60 times faster than a single DN equipped with 3D convolutions.

Embodiments disclosed here provide a new approach for low-rank matrix or tensor decomposition that is robust to a wide class of signal and noise models. The core enabling observation is that DNs produce signals that are implicitly regularized due to the networks' inherent inductive bias. The method exploits DNs as priors by representing a matrix or tensor in terms of factors output from a set of untrained generative networks as shown in FIG. 1A. The parameters of the networks are learned in a self-supervised manner for each matrix or tensor using a simple MSE loss between the matrix or tensor and the product of the deeply generated factors. The inductive bias of the generative networks enables better identification of the underlying low-dimensional subspace while rejecting noise, resulting in a more accurate estimate of the noise-free matrix or tensor.

As shown in FIG. 1A, the low-rank decomposition method exploits DNs as priors by representing a tensor (107) in terms of factors (105, 106) output from a set of respective untrained generative networks (103, 104) which use respective pluralities of smaller input tensors (101, 102). Specifically, the low-rank decomposition method exploits the implicit regularization capabilities of DNs. Further, the factorization is achieved by learning parameters of the networks (103, 104) in a self-supervised manner that reduces the loss between the factors (105, 106) and the input tensors (101, 102). As shown in FIG. 1A, network 103 has 4 layers and network 104 has 3 layers. Therefore each are DNs.

The method is a computationally efficient, drop-in replacement for many existing tensor factorization approaches that combines the simplicity of low-rank decomposition with the power of deep generative networks. For example, FIG. 1B shows a conventional low-rank factorization such as SVD, which relies on linear factors (108, 109) to represent a matrix (110).

Further, the method can significantly improve the performance of downstream tasks, such as image classification, that rely on low dimensional representation. The disclosure empirically backs these characterizations of the method via experiments on a wide variety of real-world tasks, including denoising with low-rank approximation, “eigenfaces” for facial recognition, solving linear inverse problems with compressively sensed videos, tensor denoising, and recovery of 3D volumes from computed tomographic (CT) measurements. The disclosure also highlights the computational efficiency and scalability for large and higher-order tensor decomposition by demonstrating that it offers a 60 times (60×) or more speedup for decomposing 3D tensors as compared to a single generative network equipped with full 3D convolutions.

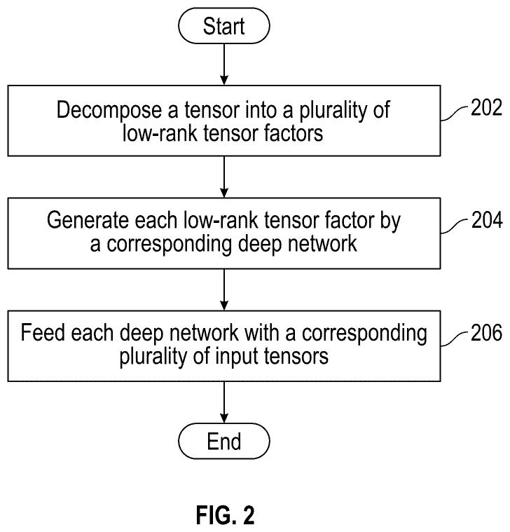

FIG. 2 shows a flowchart in accordance with one or more embodiments. Specifically, the flowchart illustrates a method for visibility enhancement of color image and video. Further, one or more blocks in FIG. 2 may be performed by one or more components as described in FIG. 1. While the various blocks in FIG. 2 are presented and described sequentially, one of ordinary skill in the art will appreciate that some or all of the blocks may be executed in a different order, may be combined or omitted, and some or all of the blocks may be executed in parallel. Furthermore, the blocks may be performed actively or passively.

In block 202, a tensor (107) is decomposed into a plurality of low-rank tensor factors (105, 106). Low-rank approximation seeks to represent a matrix X (107)∈RM×N of rank R=min(M, N) as a product of two smaller matrices, U (105)∈RM×k, V (106)∈RN×k where k is generally taken to be smaller than R. The specific constraints on U, V, and the desired objective give rise to different types of low-rank approximation algorithms. For comparison, equation (1) recovers PCA, equation (2) recovers nonnegative matrix factorization (NMF), and equation (3) recovers k-means.

$${min}_{{u}^{′} , {v}^{′}} {‖ {X}^{′} - {U}^{′} {V}^{′ T} ‖}_{F} s . t . {U}^{′} = {V}^{′ T} \qquad ( Equation 1 )$$

$${min}_{{u}^{′} , {v}^{′}} {‖ {X}^{′} - {U}^{′} {V}^{′ T} ‖}_{F} s . t . {U}^{′} \geq 0 , {V}^{′} \geq 0 \qquad ( Equation 2 )$$

$${min}_{{u}^{′} , {v}^{′}} {‖ {X}^{′} - {U}^{′} {V}^{′ T} ‖}_{F} s . t . [ {V}^{′} ] . {,}_{k} ∈ \{ {e}_{1} , … {e}_{n} \} \qquad ( Equation 3 )$$

where ek denotes the kth Euclidean canonical basis vector, and [V′].,k denotes the kth column of V′. Applications of low-rank approximation are extremely diverse ranging from denoising, compression, clustering for anomaly detection, and forecasting.

In block 204, each low-rank tensor factor (105, 106) is generated by a corresponding deep network (103, 104). In block 206, each deep network (103, 104) is fed by a plurality of input tensors (101, 102). DNs have emerged very rapidly from classification and regression applications where they have reached advanced performance across a wide range of datasets and tasks. Specifically, a DN f is used as a constrained projection of a random noise vector z to fit a target sample x as follows in equation (4)

$${min}_{θ} {‖ {f}_{θ} ( z ) - x ‖}_{2}^{2} \qquad ( Equation 4 )$$

When the architecture of the DN is carefully picked, the estimation of the input x is denoised, and well reconstructed even in the presence of missing values. From the implicit regularization field it is understood that the above problem is equivalent to equation (5)

$${min}_{W} {‖ Wz - x ‖}_{2}^{2} + R ( W ) \qquad ( Equation 5 )$$

where R(W) is a regularization term that directly depends on the choice of the DN architecture. Therefore, searching for the DN parameters producing the desired result in equation (4) is equivalent to searching in the space of regularizers in equation (5).

For comparison, when the regularizers for U′ (108) and V′ (109) are included in equation (1), the following optimization function is obtained

$${min}_{{u}^{′} , {v}^{′}} {‖ {X}^{′} - {U}^{′} {V}^{′ T} ‖}^{2} + R ( {U}^{′} , {V}^{′} ) \qquad ( Equation 6 )$$

where R(U′, V′) is a regularizer for U′, V′. Instead of having explicit regularizers on the left and right matrices, we model U (105), V (106) as the outputs of generative networks f_{U}, f_{V} which yields

$${min}_{{θ}_{U} , {θ}_{V}} {‖ X - {f}_{U} ( {z}_{U} ) {f}_{V} ( {z}_{V} ) ‖}^{2} \qquad ( Equation 7 )$$

where z_{U} and z_{V} are randomly initialized inputs to the networks f_{U}, f_{V} respectively that have parameters θ_{U}, θ_{V}. The networks' output U and V are of the same shape as the U′ and V′ matrices from the equation (6). However, there is no further regularizer on the matrices U and V, as any regularization comes from the implicit prior of the DN itself, which makes it an appealing choice to solve a diverse type of signals and noise settings.

Additionally, the task of tensor decomposition finds numerous applications and is an active area of research, where the major difficulty rises from defining an appropriate regularizer/basis constraint. Any constraint on the factor matrices can be expressed as regularization functions. For comparison, given the following general decomposition equation

with X′ a k-dimensional tensor, one needs to specify the correct regularizer (R) such that the produced decomposition is adapted for the task at hand. This search is mostly understood in narrowly defined settings such as Gaussian noise and Gaussian latent space factors. However, the present disclosure solves the following optimization to compute the decomposition
where f_{U}, f_{V} . . . , f_{W} are k DNs that are fed with input vectors z_{U}, z_{V}, . . . , z_{W} with parameters θ_{U}, θ_{V}, θ_{W}, respectively.

While it is possible to represent the matrix X itself via a DN prior, doing so will require a 2D network instead of two 1D networks. However, an exponential computational time gain may be achieved by separating the dimensionality of the tensor and doing the tensor products of multiple independent DN outputs, as shown in equation (9), representing separable convolutions. Thus, dimensionality splitting brings tractability without sacrificing performance.

For exemplary purposes, the low-rank model finds use in numerous applications in computer vision including sensing of light transport matrices, hyperspectral imaging, video compressive sensing, magnetic resonance imaging (MRI), and positron emission tomography (PET). Most inverse problems involve collection of limited data samples and/or highly noisy samples.

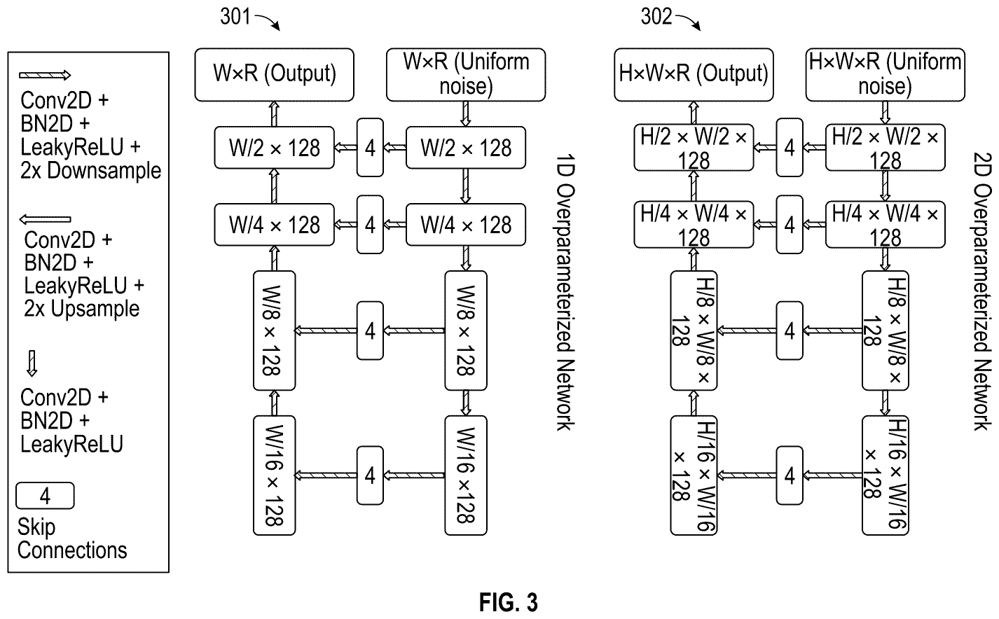

FIG. 3 shows exemplary architectures for 1D (301) and 2D (302) overparameterized networks. The DeepTensor may utilize overparameterized networks for the factor matrices, similar to Deep Image Prior. However, it is possible to use under parameterized networks instead, similar to the deep decoder architecture. The advantage of the latter is that the learned parameters can be used as the compressed version of the tensor being decomposed. In contrast, for pure data imputation and denoising overparameterized networks are preferred. Unless otherwise specified, the examples described herein utilize overparametrized networks for the factor matrices.

In one or more embodiments, overparameterized networks are used with skip connections. The networks may be trained with a learning rate between 10⁻² and 10⁻⁵, for example 10⁻³. Further, the training process may be implemented in Python using the Pytorch framework, on a computer processor. Specifically, the number of output channels was changed to be equal to the rank for all factor matrices. For tensor decomposition with 1D fibers, the 2D convolutional architecture was changed to a 1D architecture. Both inputs and network parameters were optimized which provided faster convergence. In one or more embodiments, the DeepTensor may be combined with additional constraints such as nonnegativity on U, V.

The parameters of the networks that output the factor matrices may be optimized using stochastic gradient descent. The stochastic gradient descent may be implemented in the form of an Adam optimizer implemented using PyTorch framework. For all experiments described herein, an l2 loss function was optimized between the data and the product of outputs of DNs. The primary purpose of choosing a simple loss function was to emphasize on the regularization capabilities of the DNs. In practice, it is possible to choose a more appropriate loss function for each specific problem.

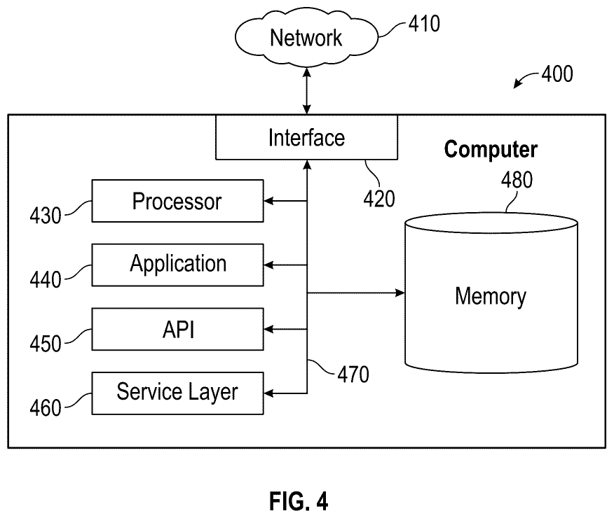

Embodiments may be implemented on any suitable computing device, such as the computer system shown in FIG. 4. FIG. 4 is a block diagram of a computer system (400) used to provide computational functionalities associated with described algorithms, methods, functions, processes, flows, and procedures as described in the instant disclosure, according to an implementation. Additionally, the embodiments may be implemented as a standalone software or a plug-in using another software to operate. The illustrated computer (400) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (400) may include a computer that includes an input device, such as a keypad, keyboard, touch screen, or other device that can accept user information, and an output device that conveys information associated with the operation of the computer (400), including digital data, visual, or audio information (or a combination of information), or a GUI.

The computer (400) can serve in a role as a client, network component, a server, a database or other persistency, or any other component (or a combination of roles) of a computer system for performing the subject matter described in the instant disclosure. The illustrated computer (400) is communicably coupled with a network (410). In some implementations, one or more components of the computer (400) may be configured to operate within environments, including cloud-computing-based, local, global, or other environment (or a combination of environments).

At a high level, the computer (400) is an electronic computing device operable to receive, transmit, process, store, or manage data and information associated with the described subject matter. According to some implementations, the computer (400) may also include or be communicably coupled with an application server, e-mail server, web server, caching server, streaming data server, business intelligence (BI) server, or other server (or a combination of servers).

The computer (400) can receive requests over network (410) from a client application (for example, executing on another computer (400) and responding to the received requests by processing the said requests in an appropriate software application. In addition, requests may also be sent to the computer (400) from internal users (for example, from a command console or by other appropriate access method), external or third-parties, other automated applications, as well as any other appropriate entities, individuals, systems, or computers.

Each of the components of the computer (400) can communicate using a system bus (370). In some implementations, any or all of the components of the computer (400), both hardware or software (or a combination of hardware and software), may interface with each other or the interface (420) (or a combination of both) over the system bus (470) using an application programming interface (API) (450) or a service layer (460) (or a combination of the API (450) and service layer (460). The API (450) may include specifications for routines, data structures, and object classes. The API (450) may be either computer-language independent or dependent and refer to a complete interface, a single function, or even a set of APIs. The service layer (460) provides software services to the computer (400) or other components (whether or not illustrated) that are communicably coupled to the computer (400). The functionality of the computer (400) may be accessible for all service consumers using this service layer. Software services, such as those provided by the service layer (460), provide reusable, defined business functionalities through a defined interface. For example, the interface may be software written in JAVA, C++, or other suitable language providing data in extensible markup language (XML) format or other suitable format. While illustrated as an integrated component of the computer (400), alternative implementations may illustrate the API (450) or the service layer (460) as stand-alone components in relation to other components of the computer (400) or other components (whether or not illustrated) that are communicably coupled to the computer (400). Moreover, any or all parts of the API (450) or the service layer (460) may be implemented as child or sub-modules of another software module, enterprise application, or hardware module without departing from the scope of this disclosure.

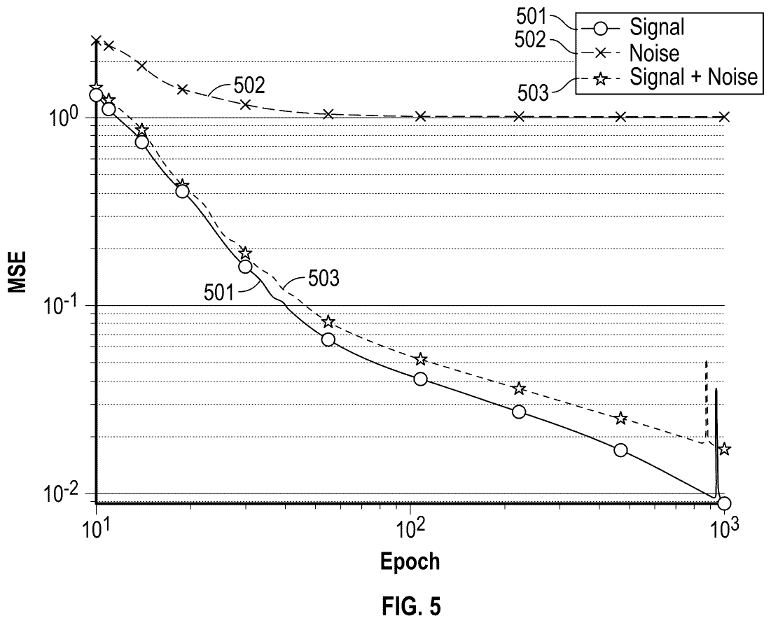

The computer (400) includes an interface (420). Although illustrated as a single interface (420) in FIG. 5, two or more interfaces (420) may be used according to particular needs, desires, or particular implementations of the computer (400). The interface (420) is used by the computer (400) for communicating with other systems in a distributed environment that are connected to the network (410). Generally, the interface (420 includes logic encoded in software or hardware (or a combination of software and hardware) and operable to communicate with the network (410). More specifically, the interface (420) may include software supporting one or more communication protocols associated with communications such that the network (410) or interface's hardware is operable to communicate physical signals within and outside of the illustrated computer (400).

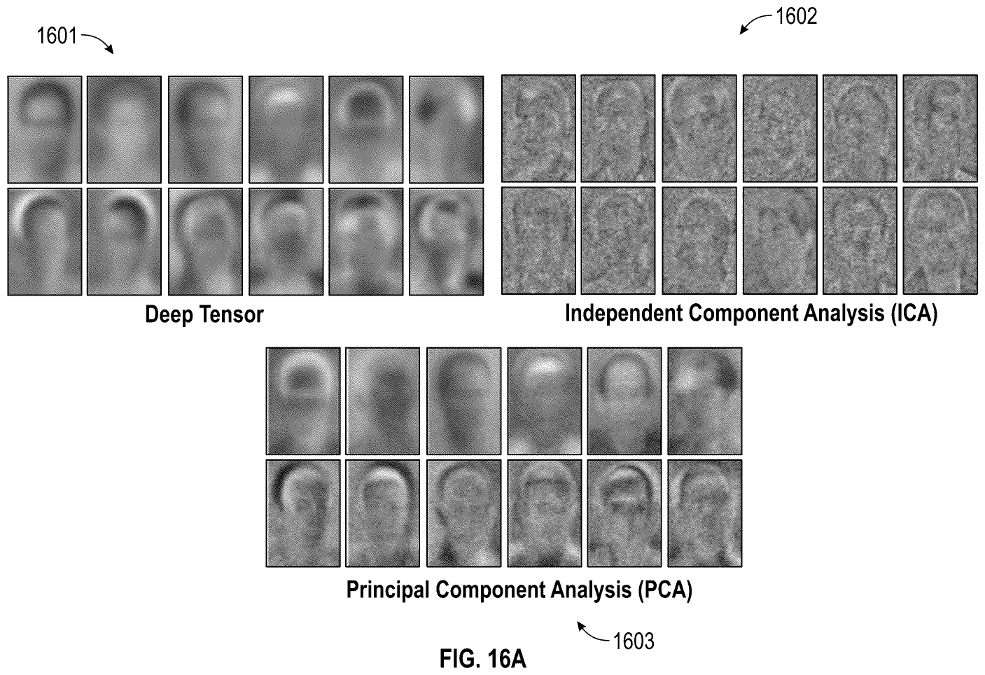

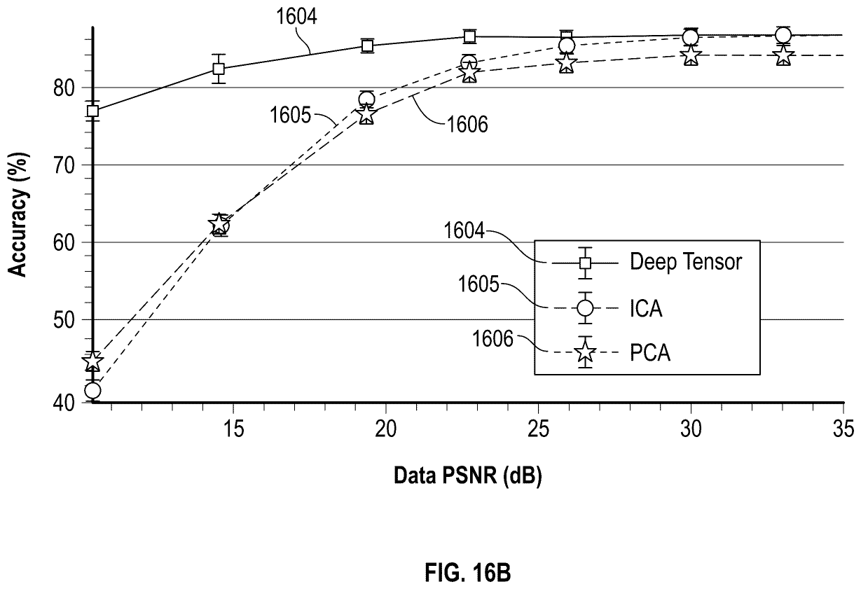

The computer (400) includes at least one computer processor (430). Although illustrated as a single computer processor (430) in FIG. 16, two or more processors may be used according to particular needs, desires, or particular implementations of the computer (400). Generally, the computer processor (430) executes instructions and manipulates data to perform the operations of the computer (400) and any algorithms, methods, functions, processes, flows, and procedures as described in the instant disclosure.

The computer (400) also includes a memory (480) that holds data for the computer (400) or other components (or a combination of both) that can be connected to the network (410). For example, memory (480) can be a database storing data consistent with this disclosure. Although illustrated as a single memory (480) in FIG. 4, two or more memories may be used according to particular needs, desires, or particular implementations of the computer (400) and the described functionality. While memory (480) is illustrated as an integral component of the computer (400), in alternative implementations, memory (480) can be external to the computer (400).

The application (440) is an algorithmic software engine providing functionality according to particular needs, desires, or particular implementations of the computer (400), particularly with respect to functionality described in this disclosure. For example, application (440) can serve as one or more components, modules, applications, etc. Further, although illustrated as a single application (440), the application (440) may be implemented as multiple applications (440) on the computer (400). In addition, although illustrated as integral to the computer (400), in alternative implementations, the application (440) can be external to the computer (400).

There may be any number of computers (400) associated with, or external to, a computer system containing computer (400), each computer (400) communicating over network (410). Further, the term “client,” “user,” and other appropriate terminology may be used interchangeably as appropriate without departing from the scope of this disclosure. Moreover, this disclosure contemplates that many users may use one computer (400), or that one user may use multiple computers (400).

In some embodiments, the computer (400) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

### EXAMPLES

These examples demonstrated that self-supervised learning is effective for solving low-rank tensor and matrix decomposition. Across the board, it is noticeable that the DeepTensor is a superior option compared to SVD/PCA when the input SNR is low, the matrix/tensor values are non-Gaussian distributed, or the inverse problem is ill-conditioned such as in the case of PCA with limited samples, or linear inverse problems. Moreover, the separable approximation approach results in faster approximation of 3D tensors compared to DNs with 3D convolutional filters.

### Example 1

Example 1 illustrates implicit regularization. FIG. 5 visualizes the implicit regularization offered by DNs for the task of rank-20 decomposition. Over 100 iterations, the error for signal (501) reduces by two orders of magnitude, while the error reduces by less than one order for noise (502). The inductive bias due to the network architecture fits better to signal and rejects noise. To test this, a rank-20 decomposition of a hyperspectral image Gaussian noise was performed with a standard deviation of 0.01 units, and a noisy signal (503) obtained by adding the hyperspectral image and the Gaussian noise. It is observed that through the training epochs, the signal is better fit by the network, while the noise has a slower fit. This slow fitting to noise is a result of implicit bias of DNs which is leveraged by the DeepTensor.

### Example 2

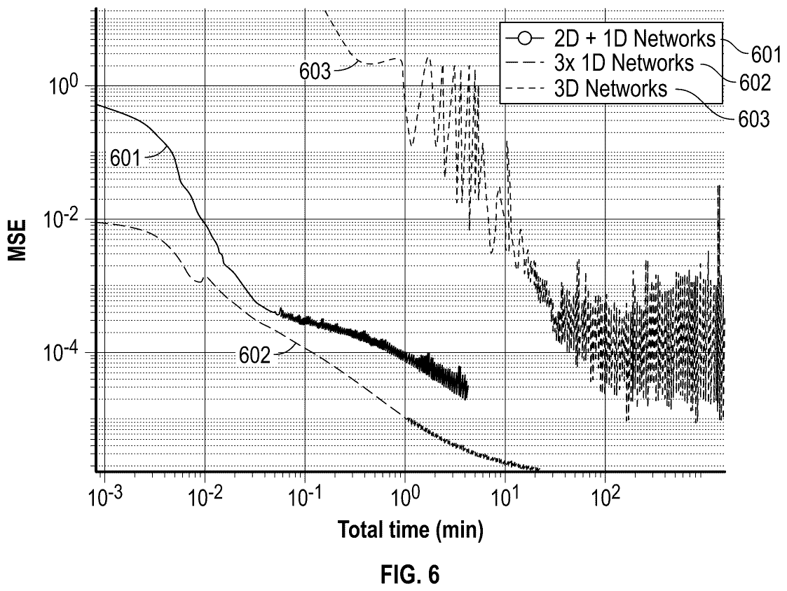

Example 2 illustrates speed-up from separable convolutions. A 3D magnetic resonance imaging (MRI) volume of size 128×128×150 was approximated with three types of networks, such as one 2D (302) and 1D network (301) as illustrated in FIG. 3, which is a natural parametrization that captures the dependence of the first two dimensions f_{U,V} (z_{U,V})⊗f_{W} (z_{W}), three 1D network (602), and one 3D network (603). FIG. 6 shows the plot of mean squared error (MSE) as a function of time for the three approaches (601, 602, 603). We note that using three 1D networks (602) is faster than using a 2D and 1D network (601), and both are two orders of magnitude faster than using one 3D network (603). Further, the 3D network is similar to the 2D network, with Conv2D and BN2D being replaced with Conv3D and BN3D, respectively. Additionally, separate parametrization has the benefit of keeping interpretability since one has access to each generated low-rank matrix that combine to form the observed data matrix X. The choice between using networks equipped with 2D and 1D convolutions, and networks equipped with 1D convolutions is specific to the task at hand. Tensors such as videos and hyperspectral images benefit from networks equipped with 2D and 1Dconvolutions. In contrast, tensors from multi-dimensional face databases or computed tomographic (CT) images benefit from a full tensor decomposition.

### Example 3

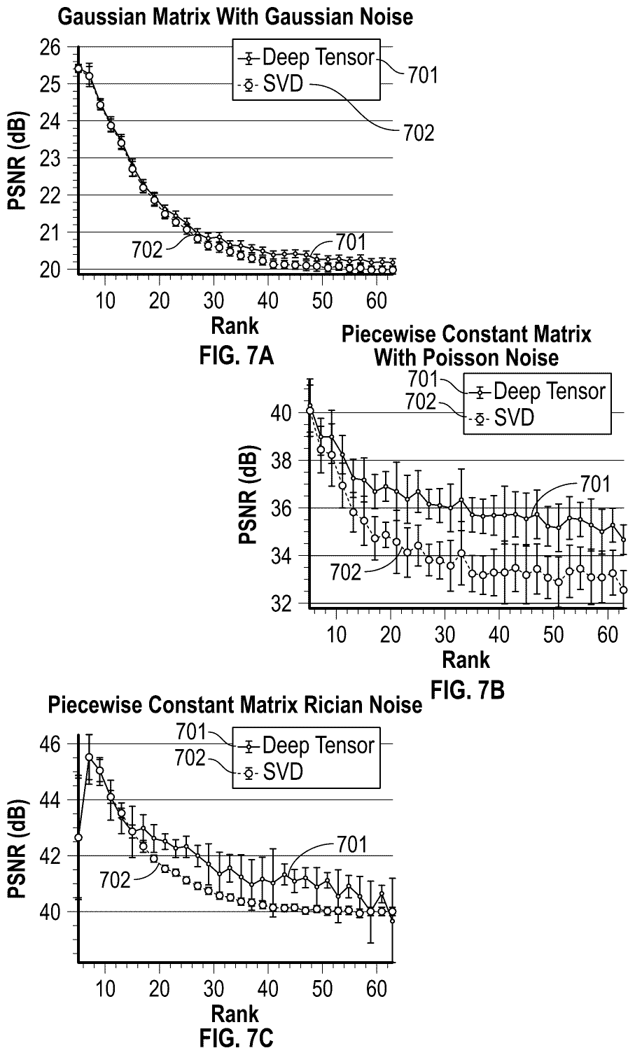

Example 3 illustrates low-rank decomposition. FIGS. 7A-7C show a trial of the low-rank decomposition with the DeepTensor (701) and SVD (702). Initially, random 64×64 dimensional matrices were generated with rank varying from 10 to 60. The left and right matrices were generated as either Gaussian values (with a standard deviation of 1 unit), or random, piecewise constant signals, emulating visual signals. Gaussian noise with standard deviation of 0.1 units: Y=X+N(0, 0.1) was added to matrices represented on FIG. 7A, Poisson noise with mean at each entry of the matrix lying in the range [0, 1000]: Y=P(1000X), which is common in visual signals was added to matrices represented on FIG. 7B, and Rician noise with standard deviation of 0.02 units: Y={square root over ((X+N(0,0.02))²+N(0,0.02)²)} that is common in MRI measurements was added to matrices represented on FIG. 7C.

Additionally, FIGS. 7A-7C show a plot of peak signal-to-noise ratio (PSNR) as a function of rank for various signal and noise types averaged over 10 realizations. In FIG. 7A, where the noise is Gaussian, the DeepTensor has similar performance to SVD/PCA, since SVD/PCA is known to be the optimal low-rank decomposition for white Gaussian matrices. In FIGS. 7B and 7C, for other noise settings, such as Poisson or Rician, the DeepTensor has a far superior performance across all rank values. This empirically establishes that the DeepTensor is well suited for a range of non-Gaussian noise models.

The performance of SVD-based PCA degrades under noisy conditions or when samples are limited. To verify how the DeepTensor can benefit PCA, a variable number of data points was generated with a known intrinsic matrix generated as Gaussian random variables with mean 0 and standard deviation of 1. The feature dimension was 64 and the intrinsic dimension/rank was 10. The data was generated via a linear combination of the columns where the weights were drawn from a Gaussian distribution with mean 0 and standard deviation. The Gaussian noise was added to the data matrix with varying levels of standard deviation.

### Example 4

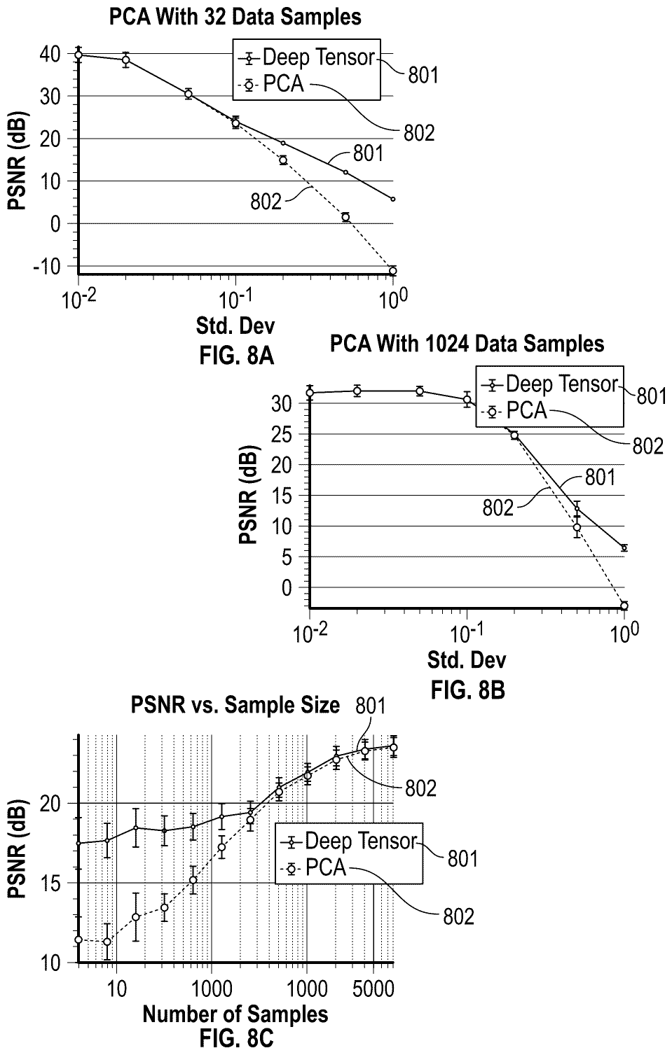

Example 4 illustrates accuracy for different sample sizes. FIGS. 8A-8C show the accuracy of estimating the DeepTensor (801) and the PCA (802) components for varying noise levels and number of samples averaged over 10 realizations. It is observed that with low noise or a large number of samples, SVD-based PCA (802) and the DeepTensor (801) have similar performance. However, with high noise or a limited number of samples, the DeepTensor (801) significantly outperforms SVD-based PCA (802).

### Example 5

Example 5 illustrates accuracy for different learning rate schedulers. In one or more embodiments, a choice of learning rate and its scheduling directly affects the maximum achievable accuracy. To gain empirical insight into how the learning rate and its scheduling affect the training process, a rank-16 low-rank decomposition of a 64×64 matrix was performed. The entries of the matrix were drawn from independent and identically distributed Gaussian distribution. The learning rates were varied from 10⁻⁵ to 10⁻², and chose four learning rate schedulers, namely fixed with no change in learning rate, step scheduler where the learning rate was multiplied by 0.99 after every 2,000 epochs, exponential scheduler with a multiplication factor of 0.9999, and cosine annealing-based scheduling.

TABLE 1

| Max learning | Scheduler | | | |
|---|---|---|---|---|
| rate | Fixed | Step | Exponential | Cosine annealing |
| 10⁻² | 17.6 ± 0.7 | 17.1 ± 0.4 | 16.6 ± 0.4 | 16.5 ± 0.3 |
| 10⁻³ | 17.5 ± 0.6 | 17.1 ± 0.5 | 16.6 ± 0.4 | 16.6 ± 0.3 |
| 10⁻⁴ | 17.6 ± 0.6 | 17.1 ± 0.4 | 16.6 ± 0.4 | 16.5 ± 0.3 |
| 10⁻⁵ | 16.5 ± 0.3 | 16.5 ± 0.2 | 16.5 ± 0.4 | 16.6 ± 0.3 |

Table 1 presents the best achievable learning rate for low-rank approximation of a toy matrix. Each experiment was repeated five times. SVD accuracy was 14.4 dB. The choice affects the final achievable accuracy-fixed scheduling with a high learning rate performs better than other choices. The fixed scheduler results in higher PSNR across all learning rates. Moreover, learning rates ranging from 10⁻⁴ to 10⁻² are equivalent choices, as a very low learning rate of 10⁻⁵ resulted in poorer PSNR. The two observations above imply that the DeepTensor does not require complex learning rate scheduling and is robust to the learning rates.

### Example 6

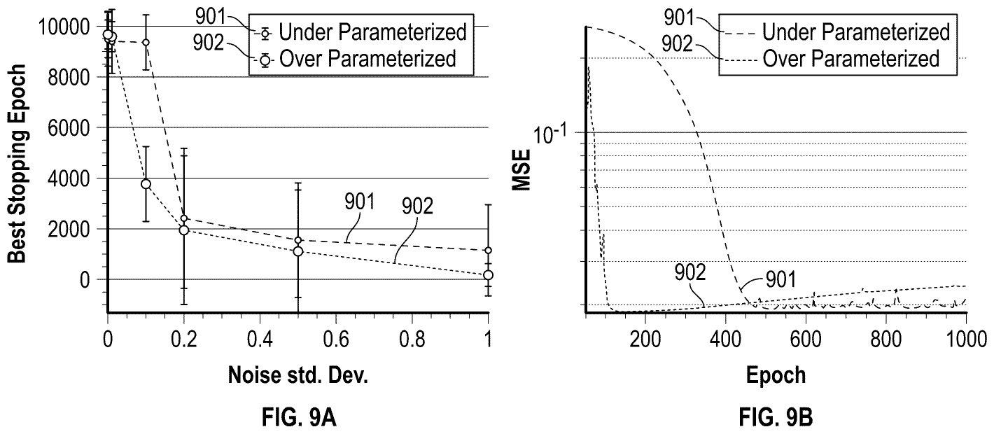

Example 6 illustrates accuracy for over parametrized and under parametrized networks. FIGS. 9A and 9B show the stopping criterion for optimal approximation accuracy is a function of input noise distribution and network architecture. To demonstrate this dependence, a rank-16 low-rank decomposition of 64×64 matrices with entries drawn from independent and identically distributed Gaussian distribution is performed. We then utilized an under-parameterized, and over-parameterized network to estimate the left and right factor matrices with varying levels of noise.

Further, FIGS. 9A and 9B compare the results with the two types of networks. FIG. 9A shows that the optimal stopping epoch reduces with increasing noise standard deviation and that both networks require fewer iterations with increasing noise level for least approximation error. FIG. 9B shows approximation error over epochs when the noise standard deviation is 0.2. Over-parameterized networks (902) achieve lower approximation error than under-parameterized networks (901). However, the error for over-parameterized networks (902) increases rapidly after optimal stopping epoch, which is 100, whereas the error increases more gently for under-parameterized (901) networks after the optimal stopping epoch, which is 500. Ultimately, the stopping criteria and the network architecture depend on the exact application and prior knowledge about noise levels in the signal.

### Example 7

Example 7 illustrates accuracy for different activation functions. In one or more embodiments, nonnegativity can be achieved with various activation functions including ReLU, softplus, and element-wise ab-solute value, and the exact choice affects the achievable accuracy. To gain an empirical insight into the effect of the activation function, NMF was used on MNIST and CIFAR datasets. In both cases, 2048 images were used for training. A Rician noise was added to the images of the form n=0.3(0.3z₁+z₂²) where z₁ and z₂ are independent and indentically distributed Gaussian random variables with zero mean and unit variance. The input PSNR was evaluated to be 4.8 dB. Further, performed NMF was performed on the resultant images with various techniques. Comparisons are tabulated in Table 2. A combination of l2 loss for was employed for data fidelity, and l1 penalty for the factor matrices output from the DNs. The DeepTensor, particularly when combined with the ReLU activation function achieves higher approximation accuracy compared to baseline NMF algorithm.

TABLE 2

| Act. func. | softplus | abs. value | ReLU |
|---|---|---|---|
| | MNIST | | |
| DeepTensor | 7.4 ± 0.03 | 7.3 ± 0.01 | 7. [symbol] ± 0.15 |
| NMF [ [symbol] ] | | 7.5 | |
| | CIFAR10 | | |
| DeepTensor | 8.4 ± 0.08 | 8.3 ± 0.06 | 8.8 ± 0.17 |
| NMF [ [symbol] ] | | 8.2 | |

[symbol]

indicates data missing or illegible when filed

Table 2 shows that the DeepTensor is a robust alternative to the NMF. The NMF was performed on MNIST and CIFAR10 datasets by enforcing nonnegativity on U, V through different activation functions. The table above shows the average PSNR over 10 runs. The DeepTensor with ReLU as the final activation function outperformed standard NMF, underscoring the efficacy for matrix factorization with positivity constraints.

### Example 8

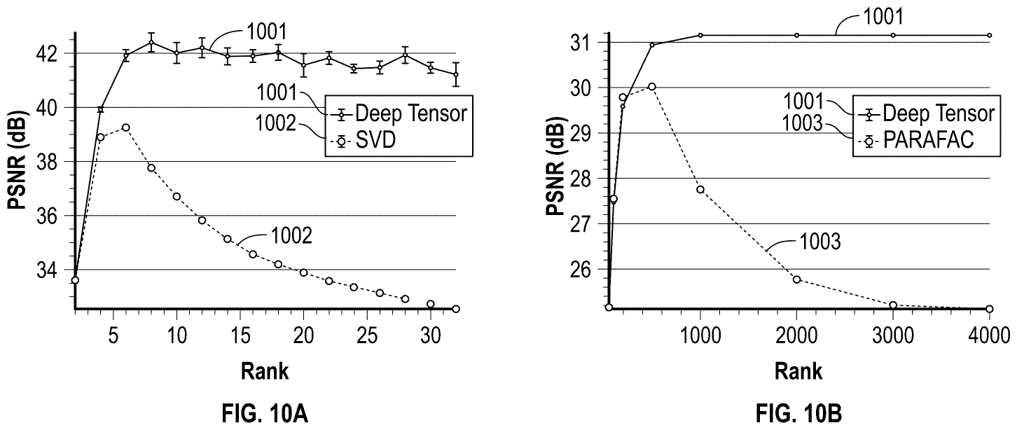

Example 8 illustrates accuracy for different choices of rank. FIGS. 10A and 10B show effects of a choice of rank. As with all matrix and tensor decomposition approaches, the rank of the decomposition is an important parameter for the DeepTensor (1001). However, this example demonstrates that the DeepTensor (1001) is less sensitive to the choice of rank than the SVD (1002) in two different settings. In the first experiment, a hyperspectral image was truncated to rank-20 and swept the rank from 1 to 30. In the second experiment, a subset of the Yale-B dataset was truncated using rank-1000 PARAFAC (1003) decomposition and then swept the decomposition rank from 10 to 4000. In both cases, Poisson (λmax=100) and Gaussian noise (σ=2) were added equivalent to a 25 dB measurement PSNR. FIGS. 10A and 10B shows plots of PSNR as a function of rank for both the cases. When the rank is under-estimated, the DeepTensor (1001) and SVD (1002) achieved similarly low accuracy. However, when the rank is over-estimated, the achievable accuracy with SVD (1002) reduces, while the accuracy with the DeepTensor (1001) stays approximately the same. The exact choice of rank is less important for the DeepTensor (1001) compared to the SVD (1002), which is significantly advantageous when the appropriate rank to use is unknown.

### Example 9

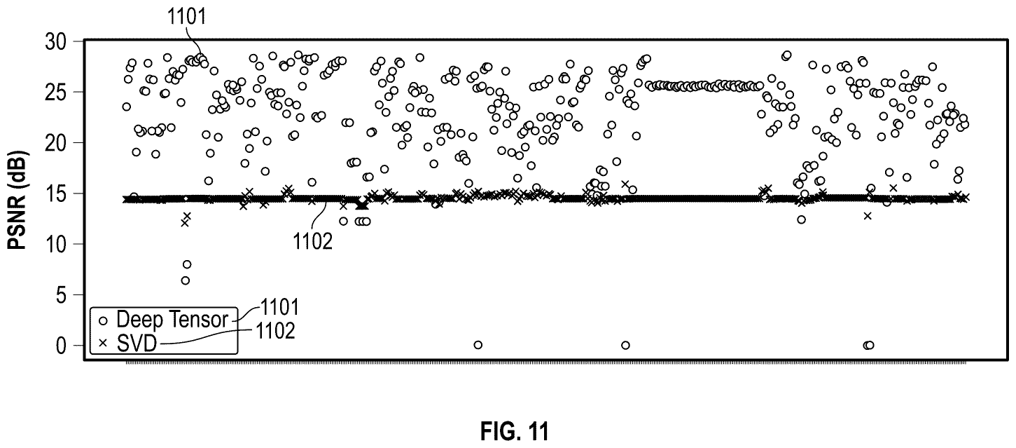

Example 9 illustrates application of the system and method to scientific computing. FIG. 11 shows an example of use of the DeepTensor for scientific computing, where the ability of the DeepTensor (1101) and the SVD (1102) were compared to represent noisy versions of the matrices from the SuiteSparse Matrix Collection, a large set of matrices from a wide variety of real applications, from electromagnetics to computer graphics and from robotics to quantum chemistry. A small amount of Gaussian noise was added, with a standard deviation of 0.5, to 430 matrices from the collection and then a low-rank approximation was computed at 50% of the ambient rank using both the SVD (1102) and the DeepTensor (1101). In each case, a matrix was approximated with N₁ rows and N₂ columns as product of two matrices, with N₁ rows and M columns, and M rows, and N₂ columns respectively, where M=min(N₁, N₂)/2 is the rank of the decomposition. Finally, the performance of each matrix was measured via the PSNR between the original matrix and its low-rank approximation. The results show that DeepTensor (1101) outperforms the SVD (1102) for 415 of the 430 matrices, often by a wide margin.

### Example 10

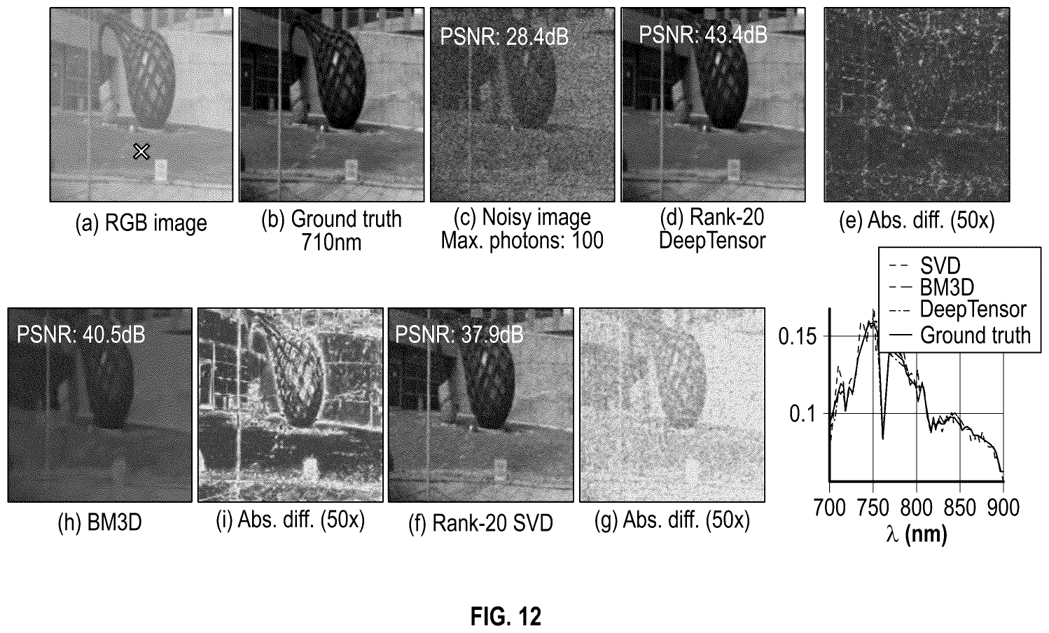

Example 10, as shown in FIG. 12, illustrates application of the system and method to hyperspectral denoising. Specifically, the low-rank models are often used for representing hyperspectral images. The low-rank models offer a concise representation of hyperspectral images (HSI) and are used in compression, sensing and dimensionality reduction. HSIs involve imaging the scene across several hundreds of spectral bands, resulting in high photon noise that is highly non-Gaussian. Typically, a HSI of dimension Nₓ×N_{y}×N_{λ} is converted to a matrix of dimension Nₓ N_{y}×N_{λ} which is then approximated using a low-rank model. A 348×327×260 HSI was denoised by simulating Poisson noise equivalent to a maximum of 100 photons per spatio-spectral voxel, and a readout noise of 2 photons. Further, a rank-20 decomposition was performed with SVD and the DeepTensor. The DeepTensor was compared against the BM3D denoising algorithm. The DeepTensor optimization process was performed for a total of 5000 iterations. The DeepTensor outperforms SVD by 6 dB, and BM3D by 3 dB and produces visually pleasing results.

### Example 11

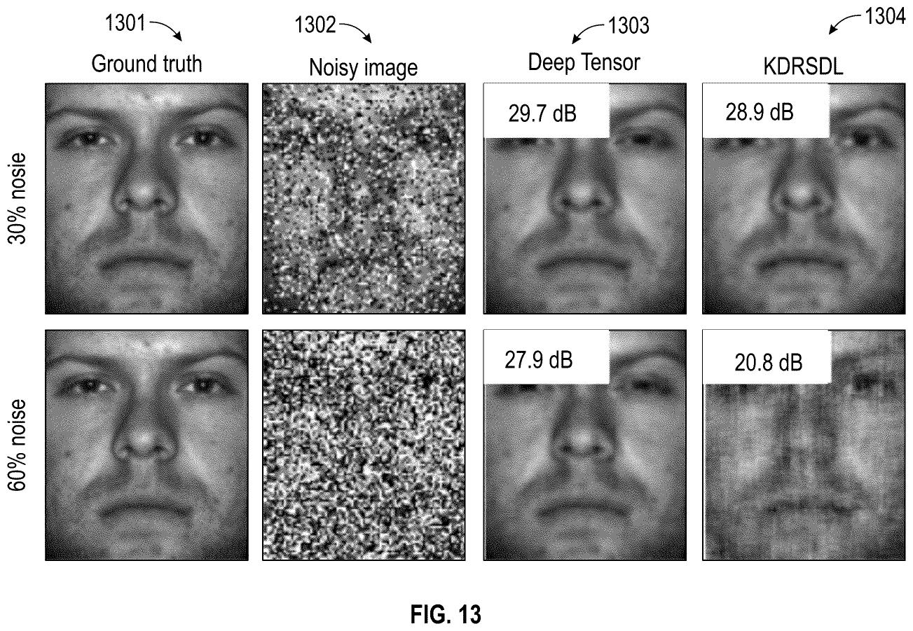

Example 11, as shown in FIG. 13, illustrates application of the system and method to tensor denoising. The DeepTensor enables denoising via low-rank tensor representation that is often better than state-of-the-art denoising techniques. The low dimensional tensor decomposition is a valid approach to tensor denoising, especially with gross outliers such as salt and pepper noise. In this example, a 3-way PARAFAC decomposition of a subset of faces from the Yale face database consisting of 160, 192×168-dimensional images (1301) was performed. The 30% salt and 60% pepper noise (1302) was added for a fair comparison against the Kronecker Decomposition-based approach (KDRSDL) (1304) which is the state-of-the-art in tensor decomposition. The results show that that an l1 penalty worked better than l2 for the DeepTensor (1303), as the noise was spatially sparse. In both cases, a rank of 2000 for PARAFAC decomposition was chosen. As shown on FIG. 13 the DeepTensor (1303) outperforms KDRSDL (1304), especially in extremely noisy settings.

### Example 12

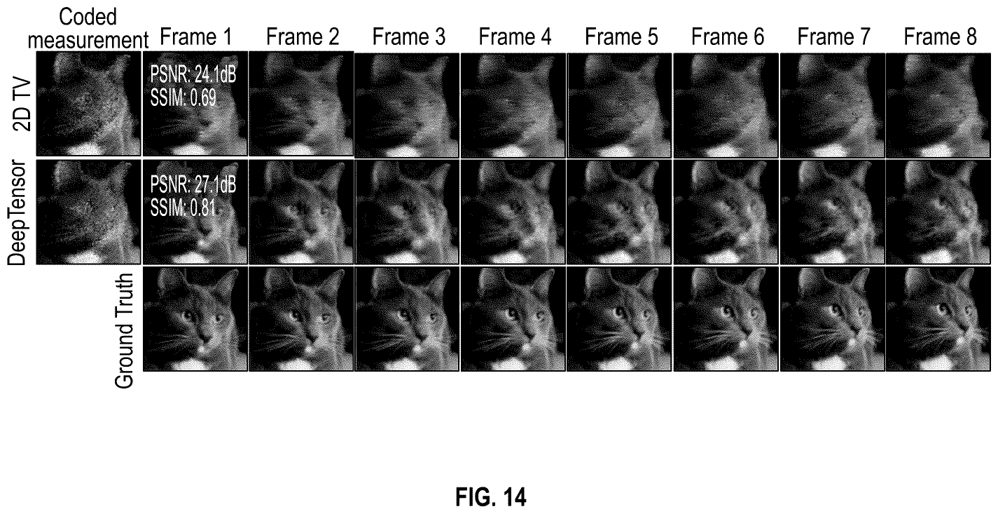

Example 12, as shown in FIG. 14, illustrates application of the system and method to video compressive sensing. The DeepTensor can be used for solving linear inverse problems with compressed measurements. The DeepTensor can also be used for full-rank decomposition, which is applicable for signals such as videos. In this example, a framework on recovery of video frames from spatially multiplexed images was used, where each pixel was sampled at an arbitrary time frame across multiple frames. Further, 8 frames were combined into one single coded image and then used the DeepTensor to solve the linear inverse problem. For comparison, a video is recovered by solving the linear inverse problem with a 2D TV over spatial images as a regularizer. The DeepTensor is trained for a total of 10,000 epochs. FIG. 14 shows coded image as well as the 8 recovered images for an example video. The DeepTensor not only has higher accuracy than TV, but the recovered images look visibly similar to ground truth.

### Example 13

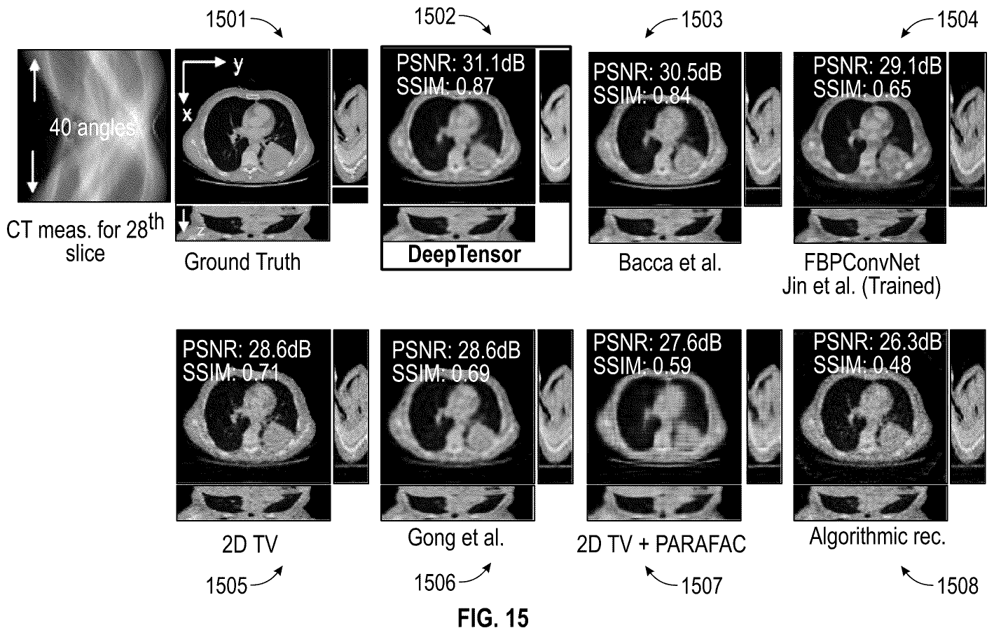

Example 13, as shown in FIG. 15, illustrated application of the system and method to 3D reconstruction from noisy CT measurements. The DeepTensor (1502) was utilized to recover 3D PET volume (1501) from limited and noisy CT images. The DeepTensor (1502) is well suited for tasks such as recovery of 3D volume from CT scans. In this Example, a 256×256×56 PET CT scan was approximated with a rank-1000 tensor. Note that although the rank is much larger than any single dimension, the effective number of parameters are only 15% of the number of elements in the 3D volume. A Poisson of maximum of 100 photons per voxel and readout noise of maximum of 2 photons per voxel were added. Further, 40 tomographic measurements were simulated for each slice.

2D TV (1505) results were obtained by a TV penalty on each slice along z-direction. “Bacca et al.” (1503) results were obtained by representing input as a rank-1000 PARAFAC tensor and using an untrained 2D network which output 56 channels. 2D TV+PARAFAC (1507) results were obtained with self-supervised learning by representing the volume via rank-1000 PARAFAC decomposition, and a TV penalty on each slice along z-axis. Algorithmic reconstruction (1508) results were obtained by solving the linear inverse problem without any other priors. FBPConvNet (1504) results were obtained by using the output of algorithmic reconstruction and then denoising with a pre-trained model. Finally, “Gong et al.” results (1506) were obtained with a self-supervised learning by using a 3D convolutional neural network, taking a 3D volume as input and outputting the predicted an x-ray tomographic (CT) image. The DeepTensor (1502) achieves better reconstruction accuracy than other approaches in both PSNR and SSIM.

### Example 14

Example 14 illustrates application of the system and method to facial recognition. FIG. 16A shows example eigenfaces for facial classification, illustrating DeepTensor as a drop-in replacement for most dimensionality reduction techniques. Further, 840 images were used across 28 subjects from the Weizmann dataset. A 25% of the data was used for training an 84-dimensional subspace via PCA, Independent Component Analysis (ICA), and the DeepTensor on the sample covariance matrix. Further, the eigenface decomposition is shown with facial data corrupted by Poisson noise. The images were converted to the 84-dimensional space and trained linear and kernel support vector machine with radial basis function and cross-validated to choose penalty that maximized classification accuracy for each individual classifier. Finally, the resultant linear subspace was evaluated along with SVM on the test data to compute average accuracy. The results shows that the basis learned from the DeepTensor (1601) is smoother and better representative of the underlying data. In contrast, the ICA (1602) and (1603) overfit the noise in data, resulting in a reduction in classification accuracy.

FIG. 16B show the accuracy of eigenface decomposition with facial data corrupted by Poisson noise for the DeepTensor (1604), the ICA (1605), and the PCA (1606). The twelve basis vectors at PSNR input of 15 dB show that the DeepTensor (1604) learns principal components that are significantly lower in noise levels compared to the ICA (1605) and PCA (1606). This in turn affects the classification accuracy that involves taking projection of input data on the principal components followed by a linear SVM classifier. As shown in FIG. 15B, DeepTensor is robust to a wide range of signal and noise models.

### Example 15

Example 15 illustrate application of the system and method to speech data, combining the DeepTensor with an additional constraints of nonnegativity on U, V. The advantages of the DeepTensor may be validated by performing an NMF on speech data obtained from the GOOGLECOM-MANDS dataset. In this example, spectrograms are computed on all speech data with a window size of 1024 samples and a hop size of 32, resulting in a 512×512 dimensional time-frequency image. Further, the noise was added resulting in an input SNR of 4.6 dB. The approximation accuracies with the DeepTensor, and a baseline NMF algorithm are shown in Table 3. The DeepTensor performs significantly better than the baseline. This ability of the DeepTensor to perform better in high noise settings is of particular significance when speech is recorded in noisy environments.

TABLE 3

| | GOOGLECOMMANDS | | | GOOGLECOMMANDS | | |
|---|---|---|---|---|---|---|
| | NMF | | | SEMI-NMF | | |
| | | abs. | | | abs. | |
| Act. func. | softplus | value | ReLU | softplus | value | ReLU |
| DeepTensor | 9.0 ± | 8.7 ± | 8.7 ± | 8.7 ± | 8.8 ± | 8.8 ± |
| | 0.03 | 0.01 | 0.03 | 0.09 | 0.02 | 0.02 |

| | | |
|---|---|---|
| baseline ([42, 51]) | 4.6 | 4.7 |

Specifically, the Table 3 shows the NMF on speech data with an average and standard deviation of the PSNR for GOOGLECOMMANDS in the NMF (nonnegativity of U, V) and semi-NMF (nonnegativity of U alone) low-rank decomposition setting for different activation functions enforcing nonnegativity. The DeepTensor with ReLU performs better than standard NMF.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for low-rank decomposition of a tensor, the method comprising:
decomposing, by a computer processor, a tensor into a plurality of low-rank tensor factors; and
generating, by the computer processor, each low-rank tensor factor by a corresponding neural network; and
feeding, by the computer processor, each neural network with a corresponding plurality of input tensors.

2. The method of claim 1, further comprising training the neural network is trained in a self-supervised manner.

3. The method of claim 1, further comprising training the neural network to minimize the mean-squared approximation error.

4. The method of claim 1, further comprising optimizing, by the computer processor, the parameters of each corresponding neural network using a corresponding stochastic gradient descent.

5. The method of claim 1, wherein decomposing the tensor comprises decomposing the tensor as the product of the low-rank tensor factors.

6. The method of claim 4, wherein the tensor is a matrix, the low-rank tensor factors are vectors, and the product is the outer product of the vectors.

7. A system for low-rank decomposition of a tensor, comprising:
a database; and
a computer processor, wherein the computer processor comprises functionality for:
decomposing, by a computer processor, a tensor into a plurality of low-rank tensor factors; and
generating, by the computer processor, each low-rank tensor factor by a corresponding neural network; and
feeding, by the computer processor, each neural network with a corresponding plurality of input tensors.

8. The system of claim 7, wherein each neural network is trained in a self-supervised manner.

9. The system of claim 7, wherein each neural network is trained to minimize the mean-squared approximation error.

10. The system of claim 7, wherein the parameters of each corresponding neural network are optimized using a corresponding stochastic gradient descent.

11. The system of claim 7, wherein the tensor is decomposed as the product of the low-rank tensors.

12. The system of claim 10, wherein the tensor is a matrix, the low-rank tensor factors are vectors, and the product is the outer product of the vectors.

13. A non-transitory computer readable medium storing instructions executable by a computer processor, the instructions comprising functionality for:
decomposing, by a computer processor, a tensor into a plurality of low-rank tensor factors; and;
generating, by the computer processor, each low-rank tensor factor by a corresponding neural network; and;
computing, by the computer processor, tensor products of a plurality of the low-rank decompositions; and
feeding, by the computer processor, each neural network with a corresponding plurality of input tensors.

14. The non-transitory computer readable medium of claim 13, wherein each neural network is trained in a self-supervised manner.

15. The non-transitory computer readable medium of claim 13, wherein each neural network is trained to minimize the mean-squared approximation error.

16. The non-transitory computer readable medium of claim 13, wherein the parameters of each corresponding neural network are optimized using a corresponding stochastic gradient descent.

17. The non-transitory computer readable medium of claim 13, wherein the tensor is decomposed as the product of the low-rank tensors.

18. The non-transitory computer readable medium of claim 16, wherein the tensor is a matrix, the low-rank tensor factors are vectors, and the product is the outer product of the vectors.
